(19) United States
(12) Patent Application Publication
(10) Pub. No.: US 2007/0170765 A1
(43) Pub. Date: Jul. 26, 2007

(54) Fitting for a vehicle seat

(75) Inventors: Gregor Vossmann, Vreden (DE); Martin Becker, Wuppertal (DE); Christoph Peters, Wermelskirchen (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GmbH & Co. KG

(21) Appl. No.: 11/710,347

(22) Filed: Feb. 23, 2007

Related U.S. Application Data
(63) Continuation of application No. PCT/EP05/07126, filed on Jul. 1, 2005.

(30) Foreign Application Priority Data
Aug. 28, 2004 (DE) 10 2004 041 735.0

(51) Int. Cl. B60N 2/02

(52) U.S. Cl. 297/367

(57) ABSTRACT

A fitting (5) for a vehicle seat, particularly for a vehicle seat, comprises: a first fitting part (7); a second fitting part (8), which can pivot about an axis (9) relative to the first fitting part (7); at least one retaining clip (11) for axially holding the fitting parts (7, 8) together; and at least one slider (15) for eliminating at least radial play between the fitting parts (7, 8) and/or the retaining clip (11).

### CROSS-REFERENCE TO RELATED APPLICATION

The present application is a continuation of International Application PCT/EP2005/007126, which was filed Jul. 1, 2005. The entire disclosure of International Application PCT/EP2005/007126, which was filed Jul. 1, 2005, is incorporated herein by reference.

### BACKGROUND OF THE INVENTION

The present invention relates to a fitting for a vehicle seat, in particular for a motor vehicle seat, with a first fitting part, a second fitting part that may be pivoted about an axis relative to the first fitting part, at least one retaining clip for axially holding the fitting parts together, and at least one slider for eliminating play between the fitting parts and/or the retaining clip.

A fitting of the type described immediately above is known from WO 00/44582 A1, and it is provided as an inclination adjuster for the backrest of a vehicle seat. In order to compensate for the weight of the backrest which is generally inclined to the rear, during the inclination adjustment (i.e. when the fitting is unlocked) a backrest compensating spring is provided which urges the backrest forward in the direction of travel and at the same time compensates for play which is possibly present in the fitting. Such a fitting could also be used as a simple backrest hinge fitting, which pivots the backrest forward into an approximately horizontal position about an axis which is located higher relative to the inclination adjustment. Therefore, no compensating spring is required. Nevertheless, due to corresponding tolerances, play may occur which leads to an undesirable generation of noise.

### BRIEF SUMMARY OF SOME ASPECTS OF THE INVENTION

An aspect of the present invention is the provision of improvements to a fitting of the type described above. In accordance with one aspect of the present invention, a fitting for a vehicle seat, in particular for a motor vehicle seat, includes a first fitting part, a second fitting part that can be pivoted about an axis relative to the first fitting part, at least one retaining clip for axially holding the fitting parts together, and at least one slider for eliminating at least radial play between the first and second fitting parts and/or the retaining clip.

Because the slider eliminates radial play which is required by-the specific mounting of the fitting part with appropriate tolerances, the generation of noise is prevented, even with a fitting used without a compensating spring, for example for vehicle seats with fold-flat functions or free-swing functions. The slider is, therefore, preferably arranged at least partially radially between the retaining clip and the second fitting part. It is also preferably arranged such that the retaining clip is attached to the first fitting part and overlaps the second fitting part by the interposition of the slider. Thus the slider also eliminates axial play, for which it preferably has a base plate arranged between the second fitting part and the retaining clip. A preferred simple attachment of the slider to the retaining clip is preferably carried out by means of projections gripping in apertures, with the projections being able to be formed on the base plate.

For the partial radial arrangement of the slider between the retaining clip and the second fitting part, the slider preferably has a compartment which, for example, is largely received by a recess of the retaining clip, and for example projects radially inward over the retaining clip. A plug-in unit is preferably able to be inserted into this compartment, for example in the axial direction, in order to widen the compartment, in particular as a result of a wedge surface which preferably bears against the retaining clip as a radially outward facing side wall of the compartment and is widened such that the compartment is forced radially inward when the plug-in unit is inserted. The compartment, therefore, preferably has a functional surface on the radially inward located face which, in particular after inserting the plug-in unit into the compartment, bears against a shoulder of the second fitting part, in order to eliminate radial play. In the inserted state, the plug-in unit is, for example, held positively and/or non-positively by projections.

Alternatively, the slider may have a fixed wedge arranged radially between the second fitting part and the retaining clip as well as a sliding wedge, which is movable relative to the fixed wedge in the axial direction and—as a result of appropriate oblique surfaces—in the radial direction. Due to the relative movement of the two wedges, ultimately with an axial lowering of the sliding wedge, one respective support face is able to bear against the retaining clip and/or against a shoulder of the second fitting part in the radial direction, in order to eliminate play.

The tolerances requiring radial play are preferably over-compensated, so that when the plug-in unit is inserted or the sliding wedge is lowered, the assembled slider is preferably subjected to thermal treatment or ultrasonic treatment in order to be individually adapted to the play which is present.

Other aspects and advantages of the present invention will become apparent from the following.

### BRIEF DESCRIPTION OF THE DRAWINGS

The invention is described in more detail hereinafter with reference to two embodiments shown in the drawings, in which:

FIG. 1 is a view of the first embodiment before the insertion of the plug-in unit into the compartment,

FIG. 2 is an axial plan view of a slider before the insertion of the plug-in unit into the compartment,

FIG. 3 is a side view of the slider from the direction of the arrow III in FIG. 2,

FIG. 4 is a section along the line IV-IV in FIG. 2,

FIG. 5 is a section along the line V-V in FIG. 4,

FIG. 6 is a section along the line VI-VI in FIG. 4,

FIG. 7 is a schematic view of a vehicle seat,

FIG. 8 is an axial plan view of a slider of the second embodiment before folding down and lowering the sliding wedge,

FIG. 9 is a side view of the slider from the direction of the arrow IX in FIG. 8,

FIG. 10 is a section along the line X-X in FIGS. 8 and 9, and

FIG. 11 is a section corresponding to FIG. 10 after the mounting of the fitting.

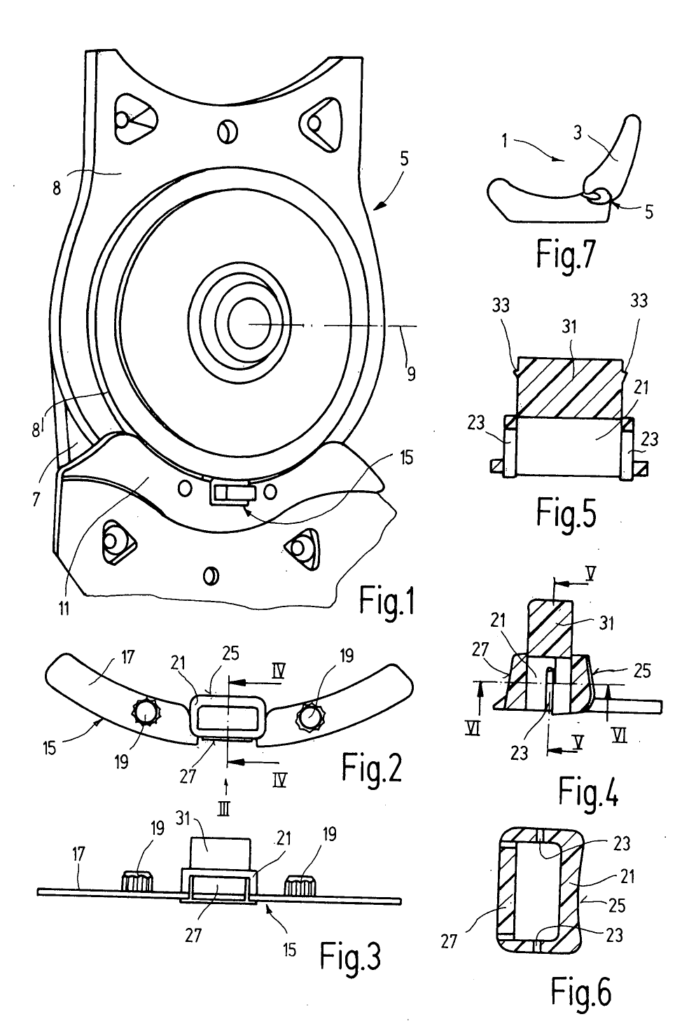

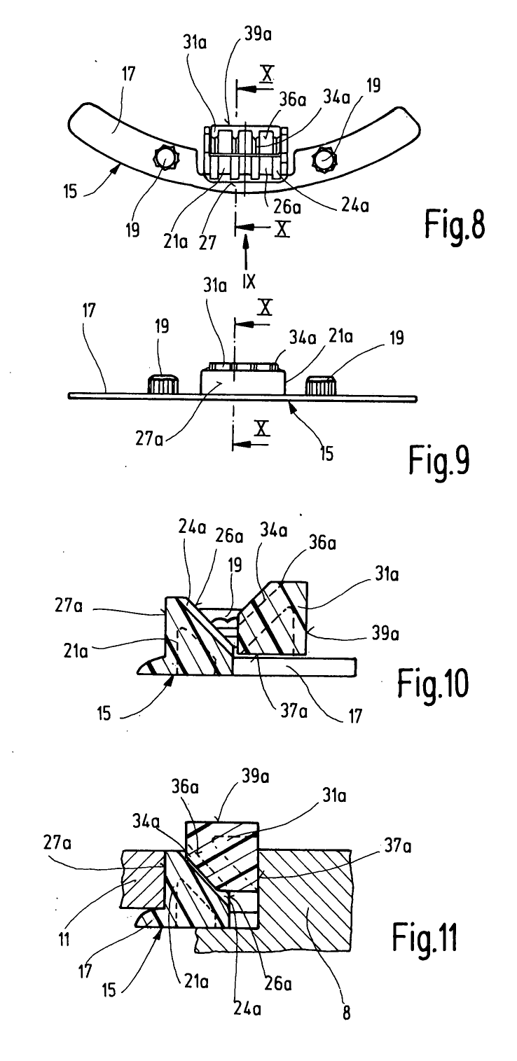

### DETAILED DESCRIPTION OF EXEMPLARY EMBODIMENTS

A vehicle seat 1 of a motor vehicle is provided on the two vehicle seat sides with a fitting 5 for easy folding down of its backrest 3 from a position of use into a fold-flat position. The basic mode of operation of this fitting 5 is explained in WO 00/44852 A1. The entire disclosure of WO 00/44852 A1 is incorporated herein by reference. The fitting 5 has a first fitting part 7, which is fixed to the structure of the seat part, and a second fitting part 8, which is fixed to the structure of the backrest. The second fitting part 8 is mounted for pivoting relative to the first fitting part 7 on a pin defining an axis 9. The axis 9 forms the backrest pivot axis and defines the frame of reference used hereinafter in terms of cylindrical coordinates.

For holding the two fitting parts 7 and 8 axially together, a retaining clip 11 is attached, preferably welded, to the first fitting part 7. The retaining clip 11 overlaps the edge of the second fitting part 8 by means of a type of angled section which in this overlap region is of circular disk-shaped configuration. In this overlap region, therefore, the second fitting part 8 is arranged in the axial direction between the first fitting part 7 and the retaining clip 11. A corresponding retaining clip is offset by 180° relative to the axis 9 and attached to the second fitting part 8 and overlaps the first fitting part 7. The retaining clip 11 may be a formed component of a customized adapter for the vehicle seat, with the adapter forming the connection with the structure of the seat part of the vehicle seat 1.

To improve the sliding properties when pivoting the two metallic fitting parts 7 and 8 relative to one another and for compensating for axial play due to tolerances, a slider 15 is provided between the second fitting part 8 and the retaining clip 11. The slider 15 is produced from plastic in an injection-molding process and has a quarter-circular-arc-shaped base plate 17 that curves about the axis 9. The base plate 17 is substantially smaller in the axial direction than in the radial direction. Two approximately cylindrical projections 19 project from the base plate 17 parallel to the axis 9. The projections 19 comprise axial ribs. To this extent, the two embodiments correspond.

The slider 15 of the first embodiment has in the center of the base plate 17 between the two projections 19 a compartment 21. The compartment 21 is hollow, divides the base plate 17 into two halves, has an approximately rectangular cross-section perpendicular to the axial direction, and extends in the axial direction slightly further than the projections 19. Of the four side walls of the compartment 21, two of the side walls are provided with slots 23, which extend in the axial direction, and these two side walls respectively face toward the projections 19; the wall located radially inward is provided as a functional surface 25 for bearing against a shoulder 8′ of the second fitting part 8; and the wall located radially outward is hereinafter denoted as the wedge surface 27. The wedge surface 27 is separated from the two adjacent side walls by defining slots, and has in the axial direction towards the second fitting part 8 an increasing wall thickness. On the axial end of the compartment 21 facing away from the second fitting part 8, during the manufacture of the slider 15 a substantially cuboid plug-in unit 31 is formed, with there being only thin material bridges connecting the plug-in unit to the compartment 21. The plug-in unit 31 has on two faces (towards the projections 17) one respective projection 33 which tapers toward the compartment 21.

During the mounting of the fitting 5, the slider 15 is attached to the retaining clip 11. This attachment is carried out by the projections 19 being inserted into circular apertures of the retaining clip 11, and the compartment 21 being inserted into a lateral (i.e. radially inward) open recess of the retaining clip 11 in the axial direction. The axial ribs of the projections 19 deform when inserted into the apertures of the retaining clip 11 such that a contact pressure is created which ensures a rigid and secure fit of the projections 19 in the apertures. The wedge surface 27 which, in contrast to the functional surface 25, is not aligned in the axial direction but slightly obliquely thereto, pivots slightly into the inside of the compartment 21 when introduced into the retaining clip 11. The retaining clip 11 prepared in this manner is positioned on the first fitting part 7 and welded thereto.

The plug-in unit 31 is now forced in the axial direction, firstly the material bridges being broken and then the plug-in unit 31 being inserted into the compartment 21. Due to the pivoted-in wedge surface 27, the compartment 21 is therefore widened, i.e. the functional surface 25 is forced out (moved inward in the radial direction), whereby the functional surface 25 bears against the shoulder 8′ of the second fitting part 8 in the radial direction and eliminates the play due to radial tolerances between the two fitting parts 7 and 8. The plug-in unit 31 is held in the compartment 21 by its projections 33 entering the slots 23 of the compartment 21 and, in the completely inserted state, it is positively supported on the front-face edges of the slots 23.

The dimensions of the compartment 21 are selected such that even large radial tolerances of the two fitting parts 7 and 8 (i.e. large spaces between the functional surface 25 and the shoulder 8′) may be compensated, so that in most cases there is an overcompensation of the radial tolerances. A subsequent thermal treatment, for which generally the temperatures of the painting process are sufficient, ensures that the slider 15 is adapted to the play which is present in each case and compensates for the tolerances.

On the other retaining clip, a simplified slider made up of the base plate and the projections is generally sufficient.

The second embodiment corresponds to the first embodiment, insofar as it is not described differently hereinafter, which is why the same components carry the same reference numerals and equally-acting components carry reference numerals supplemented by a letter. The slider 15 of the second embodiment, in the center of the base plate 17 between the two projections 19, has a fixed wedge 21a, a rectangular first support surface 27a, and one respective approximately triangular face projecting perpendicularly from the base plate 17 and facing towards each projection 19. The fixed wedge 21a has an approximately prismatic basic shape with a first oblique surface 26a arranged at 45° to the base plate 17. The first oblique surface 26a is provided with four parallel grooves 24a. The first oblique surface 26a starts radially inward at the plane of the base plate 17 and extends axially and radially outward. The rectangular first support surface 27a is positioned radially outward and projects perpendicularly from the base plate 17. The common edge of the first oblique surface 26a and the first support surface 27a is arranged in the axial direction slightly further to the outside than the projections 19.

During the manufacture of the slider 15, a sliding wedge 31a is formed laterally with only thin material bridges on the triangular faces of the fixed wedge 21a and arranged on the face located radially inward. The sliding wedge 31a also has an approximately prismatic basic shape with: a second oblique surface 36a arranged at 45° to the base plate 17 and provided with four parallel ribs 34a, which initially starts radially outward proximate the plane of the base plate 17 and extends axially and radially inward; a rectangular second support surface 37a located initially in the plane of the base plate 17; approximately triangular faces projecting perpendicularly from the plane of the base plate 17 and respectively facing toward the projections 19; and an initially radially inward facing contact surface 39a.

Accordingly, as in the first embodiment, during the mounting of the fitting 5, the slider 15 is attached to the retaining clip 11 by the projections 19 (by creating the contact pressure) being inserted into circular apertures of the retaining clip 11 and the fixed wedge 21a being inserted into a lateral, i.e. radially inward, open recess of the retaining clip 11, in the axial direction. The retaining clip 11 thus prepared is placed on the first fitting part 7, the sliding wedge 31a folding onto the fixed wedge 21a by bearing against the shoulder 8′, and then the retaining clip 11 is welded to the first fitting part 7.

By the impingement of the now axially outward facing contact surface 39a of the sliding wedge 31a, the second oblique surface 36a of the sliding wedge 31a is now brought to bear against the first oblique surface 26a of the fixed wedge 21a, the ribs 34a engaging in the grooves 24a. The impingement is carried out by means of an ultrasonic sonotrode which, on the one hand, lowers the sliding wedge 31a axially inward by mechanical pressure. In this connection, the oblique surfaces 26a and 36a slide past one another, guided by the ribs 34a and the grooves 24a, while at the same time the second support surface 37a bears radially inward against the shoulder 8′ of the second fitting part 8, supported radially outward by the first support surface 27a. On the other hand, after complete compensation of play, the ultrasonic sonotrode softens the material of the ribs 34a and thus fills the grooves 24a. After the hardening of the material, the two wedges 21a and 31a are welded fixedly to one another and thus remain in the position in which play is completely compensated.

Also in this second embodiment, the dimensions of the slider 15 are selected such that even large radial tolerances of the two fitting parts 7 and 8, i.e. large spacings between the second support surface 37a and the shoulder 8′ may be compensated, so that in most cases there is an overcompensation of the radial tolerances. The ultrasonic welding ensures that the wedges 21a and 31a are connected to one another and held in position with complete compensation of play.

In a modified design, the ultrasonic sonotrode softens the entire material of the two wedges 21a and 31a until the gaps on the fitting parts 7 and 8 are filled by adapting to the play which is present in each case and compensating for the tolerances. It is therefore advantageous if the two wedges 21a and 31a have hollow spaces into which surplus material is able to escape.

It will be understood by those skilled in the art that while the present invention has been discussed above with reference to exemplary embodiments, various additions, modifications and changes can be made thereto without departing from the spirit and scope of the invention as set forth in the following claims.

That which is claimed:

1. A fitting for a vehicle seat, with the fitting comprising:
a first fitting part;
a second fitting part that can be pivoted about an axis relative to the first fitting part;
at least one retaining clip for axially holding the fitting parts together; and
at least one slider for eliminating at least radial play between the first and second fitting parts and/or the retaining clip.

2. The fitting according to claim 1, wherein:
the retaining clip is attached to the first fitting part;
a portion of the retaining clip overlaps the second fitting part; and
at least a portion of the slider is interposed between the second fitting part and the portion of the retaining clip that overlaps the second fitting part.

3. The fitting according to claim 2, wherein the slider has a base plate, and the base plate is positioned between the second fitting part and the retaining clip.

4. The fitting according to claim 1, wherein the slider has a compartment, and the compartment is positioned radially between the second fitting part and the retaining clip.

5. The fitting according to claim 4, including a plug-in unit for being inserted into the compartment.

6. The fitting according to claim 5, wherein:
the plug-in unit is inserted into the compartment; and
the plug-in unit and the compartment are configured with respect to one another so that the compartment is widened in response to the plug-in unit being inserted into the compartment.

7. The fitting according to claim 4, wherein a functional surface of the compartment bears against a shoulder of the second fitting part.

8. The fitting according to claim 1, wherein the slider has a fixed wedge arranged radially between the second fitting part and the retaining clip.

9. The fitting according to claim 8, wherein the slider has a sliding wedge that is movable, both radially and axially, relative to the fixed wedge.

10. The fitting according to claim 8, wherein:
the slider has a second wedge,
the fixed wedge and the second wedge each have a support surface,
the support surface of one of the fixed wedge and the second wedge bears against the retaining clip, and
the support surface of the other of the fixed wedge and the second wedge bears against a shoulder of the second fitting part.

11. The fitting according to claim 5, wherein:
the plug-in unit is inserted into the compartment; and
the slider reduces play in response to the plug-in unit being inserted into the compartment.

12. The fitting according to claim 8, wherein:
the slider has a sliding wedge for being lowered; and
the slider reduces play in response to the sliding wedge being lowered.

13. The fitting according to claim 5, wherein the plug-in unit is inserted into the compartment, and the plug-in unit and the compartment are connected to one another by way of thermal treatment or ultrasonic treatment.

14. The fitting according to claim 8, wherein the slider includes a second wedge, the second wedge has been lowered with respect to the fixed wedge, and the fixed wedge and the second wedge are connected to one another by way of thermal treatment or ultrasonic treatment.

15. The fitting according to claim 1 in combination with the vehicle seat, wherein the vehicle seat includes a backrest that is at least partially carried by the fitting.

16. The fitting according to claim 6, wherein:
the compartment includes a wedge surface;
the wedge surface bears against the retaining clip; and
the compartment being widened in response to the plug-in unit being inserted into the compartment comprises the compartment being widened in response to the plug-in unit being inserted into the compartment while the wedge surface of the compartment is bearing against the retaining clip.

17. The fitting according to claim 7, wherein the functional surface of the compartment bears against the shoulder of the second fitting part in response to the plug-in unit being inserted into the compartment.

18. The fitting as claimed in claim 10, wherein the bearing of the support surface against the shoulder of the second fitting part occurs in response to the sliding wedge being lowered axially inward.

19. The fitting according to claim 1, wherein:
the slider includes
a base plate that is mounted to the retaining clip and is positioned between the second fitting part and the retaining clip, and
structure that extends from the base and bears against a shoulder of the second fitting part.

20. The fitting according to claim 19, wherein:.
the retaining clip includes a recess,
part of the structure extends into the recess, and
part of the structure projects from the recess and bears against the shoulder of the second fitting part.

21. The fitting according to claim 19, wherein the structure includes:
compartment, and
a unit that is at least partially positioned in the compartment.

22. The fitting according to claim 19, wherein the structure includes:
a first wedge, and
a second wedge.

23. The fitting according to claim 19, wherein the structure includes a plurality of distinct parts that are connected to one another.

24. The fitting according to claim 20, wherein at least one of the parts comprises a wedge shape.
